(19) United States
(12) Patent Application Publication
(10) Pub. No.: US 2024/0400844 A1
(43) Pub. Date: Dec. 5, 2024

(54) ICI BUILDING RHEOLOGY MODIFIER

(71) Applicant: Rohm and Haas Company, Collegeville, PA (US)

(72) Inventors: John J. Rabasco, Allentown, PA (US); John K. Riley, Philadelphia, PA (US)

(21) Appl. No.: 18/689,294

(22) PCT Filed: Oct. 4, 2022
(86) PCT No.: PCT/US2022/045601

§ 371 Date: Mar. 5, 2024

Related U.S. Application Data
(63) Continuation of application No. 63/256,672, filed on Oct. 18, 2021.

(51) Int. Cl. C09D 7/65; C08G 18/08; C08G 18/48; C08G 18/73; C09D 5/02; C09D 7/45

(52) U.S. Cl. CPC C09D 7/65; C08G 18/0842; C08G 18/4833; C08G 18/73; C09D 5/022; C09D 5/027; C09D 7/45

(57) ABSTRACT

The present invention relates to a composition comprising an aqueous solution of a branched HEUR, and a nonionic surfactant having an HLB in the range of 11 to 19. The composition of the present invention provides a rheology modifier that provides a formulator with independent control of viscosity across low-, mid-, and high-shear rate regimes.

### BACKGROUND OF THE INVENTION

The present invention relates to a rheology modifier, more particularly a nonionic associative thickener, that can impart a desired rheology profile over a wide shear rate range.

Nonionic associative thickeners such as hydrophobically modified ethylene oxide urethane polymers (HEURs) require targeted viscosities over a wide range of shear rates (typically 10⁻⁴ to 10⁴ s⁻¹) when used to formulate aqueous systems, such as paints and coatings. Viscosities are typically measured at three shear ranges: low-shear, mid-shear, and high-shear ranges to quickly assess the rheology profile of the system being studied. A long-standing challenge in the field of nonionic associative thickener technology is adjusting the viscosity of an aqueous coating formulation within one shear rate regime while keeping the viscosity relatively unchanged in other shear rate regimes. For example, addition of a KU builder to a paint formulation builds mid-shear viscosity to a desired level while simultaneously increasing low-shear (Brookfield) and high-shear (ICI) viscosity to undesirable high levels. Similarly, addition of an ICI builder to a paint formulation will build high-shear viscosity to a targeted level, while increasing Brookfield and KU viscosities to levels that limit paint formulators' ability to achieve their targeted rheological profile with optimal balance of Brookfield, KU, and ICI viscosities. Rheological profiles are directly correlated to application performance; accordingly, there is a need in the art of nonionic associative thickeners to discover a rheology modifier that provides independent control of viscosity at low, mid, and high shear rate regimes.

### SUMMARY OF THE INVENTION

The present invention addresses a need in the art by providing a composition comprising an aqueous solution of a branched hydrophobically modified ethylene oxide urethane polymer (HEUR) and a nonionic surfactant having an HLB in the range of 11 to 19; wherein:
the branched HEUR is capped with a hydrophobic portion having a c Log P in the range of 3.5 to 7.0; the concentration of the HEUR is in the range of from 10 to 25 weight percent, based on the weight of the composition; the concentration of the surfactant is in the range of from 5 to 25 weight percent, based on the weight of the composition; and at least 90 weight percent of the composition comprises water, the HEUR, and the surfactant.

The composition of the present invention provides a way for paint formulators to independently control viscosities of paints at low-, mid-, and high-shear rate regimes.

### DETAILED DESCRIPTION OF THE INVENTION

The present invention is a composition comprising an aqueous solution of a branched hydrophobically modified ethylene oxide urethane polymer (HEUR) and a nonionic surfactant having an HLB in the range of 11 to 19; wherein:

the branched HEUR is capped with a hydrophobic portion having a c Log P in the range of 3.5 to 7.0; the concentration of the HEUR is in the range of from 10 to 25 weight percent, based on the weight of the composition; the concentration of the surfactant is in the range of from 5 to 25 weight percent, based on the weight of the composition; and at least 90 weight percent of the composition comprises water, the HEUR, and the surfactant.

As used herein, the term “branched hydrophobically modified ethylene oxide urethane polymer” (“branched HEUR”) refers to a hydrophobically modified ethylene oxide urethane polymer formed by the reaction of a polyisocyanate and a) an alcohol (or an amine); and b) a polyalkylene glycol such as polyethylene glycol, where “polyisocyanate” refers to a compound that is functionalized with at least 3 isocyanate groups.

The branched HEUR is capped with a capping agent to form a hydrophobe having a c Log P in the range of 3.5 to 7.0. The c Log P is determined using ChemBioDraw Ultra 13.0 (PerkinElmer), which uses a chemical fragment algorithm method for assessing the partition coefficient of a molecule based on its constituent parts.

The nonionic surfactant has a hydrophobic-lipophilic balance (HLB) in the range of from 11, or from 13 to 19, or to 18. HLB is calculated in accordance with Griffin, W. C., Calculation of HLB Values of Non-ionic surfactants, Am Perfumer Essent Oil Rev 6565, 26-29 (1954), and more particularly, the following equation:

$$H L B = 20 \times \frac{MW of hydrophilic group}{MW of molecule}$$

where MW is molecular weight.

Nonionic surfactants suitable for the composition of the present invention include saturated or partially unsaturated C₆-C₆₀-alkyl C₂-C₄-alkoxylates with from 2 to 100 C₂-C₄-alkylene oxide, aryl C₂-C₄-alkylene oxide, or aralkyl C₂-C₄-alkylene oxide groups. Preferred alkylene oxide groups are ethylene oxide (EO) groups; As used herein, “partially unsaturated” allows for the presence of one or more double bonds in the alkylated portion of the surfactant. Examples of nonionic surfactants include lauryl-O-(EO)₅₋₁₇H, tridecyl-O-(EO)₅₋₁₈H, castor oil-(EO)₂₀₋₈₁H, octadecyl-O-(EO)₆₋₃₁H, stearyl-O-(EO)₆₋₃₁H, octylphenyl-O-(EO)₅₋₂₀-H, nonylphenyl-O-(EO)₅₋₂₀H, and tallow amine (EO)₆-C₂₅H.

Castor oil is a mixture of fatty triglycerides, the major component having the following structure:

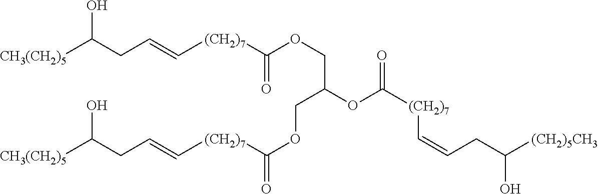

Ethoxylation, of castor oil may occur at any or all of the hydroxyl groups.

For example, for nonionic surfactant having the formula:

Dodecyl-O—(CH₂CH₂O)₉—H

The total molecular weight of this surfactant=565 g/mol; and the molecular weight of 9 moles of ethylene oxide (EO) groups=396 g/mol. Therefore,

$$H L B = 20 \times \frac{396}{582} = 13.6$$

The branched HEUR may be prepare by reacting the polyisocyanate with a stoichiometric excess of a water-soluble polyalkylene glycol, followed by reaction of the formed intermediate with a stoichiometric excess of a diisocyanate to form a branched polyurethane polymer with isocyanate groups, followed by capping of the isocyanate groups with a capping agent. Alternatively, the polyisocyanate, the diisocyanate, and the polyalkylene glycol can be contacted together under reaction conditions, followed by contacting the formed intermediate with the capping agent.

A water-soluble polyalkylene glycol refers to water-soluble polyethylene oxides, water-soluble polyethylene oxide/polypropylene oxide copolymers, and water-soluble polyethylene oxide/polybutylene oxide copolymers. As used herein, the term propylene oxide refers to either a polymer having —(OCH₂CH₂CH₂)— and/or —(OCH(CH₃)CH₂)— repeating groups. Preferred water-soluble polyalkylene oxides are polyethylene glycols, particularly polyethylene glycols having a weight average molecular weight (Mw) in the range of from 4000, more preferably from 6000, and most preferably from 7000 to 20,000, more preferably to 12,000 and most preferably to 9000 Daltons. An example of a suitable polyethylene glycol is PEG 8000, which is commercially available as CARBOWAX™ 8000 Polyethylene Glycol (a trademark of The Dow Chemical Company (“Dow”) or its affiliates).

Examples of polyisocyanates include cyanurate and biuret trimers such as HDI isocyanurate (trimer), and IPDI isocyanurate (trimer), as illustrated:

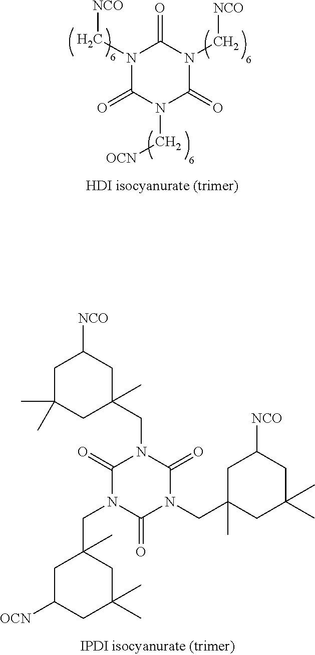

Examples of diisocyanates include 1,4-tetramethylene diisocyanate, 1,6-hexamethylene diisocyanate (HDI), 2,2,4-trimethyl-1,6-diisocyanatohexane, 1,10-decamethylene diisocyanate, 4,4′-methylenebis(isocyanatocyclohexane), 2,4′-methylenebis(isocyanatocyclohexane), 1,4-cyclohexylene diisocyanate, 1-isocyanato-3-isocyanatomethyl-3,5,5-trimethylcyclohexane (IPDI), m- and p-phenylene diisocyanate, 2,6- and 2,4-toluene diisocyanate, xylene diisocyanate, 4-chloro-1,3-phenylene diisocyanate, 4,4′-biphenylene diisocyanate, 4,4′-methylene diphenylisocyanate, 1,5-naphthylene diisocyanate, and 1,5-tetrahydronaphthylene diisocyanate. The hydrophobic portion from which calculated log P (c Log P) is derived is characterized by the following formula:

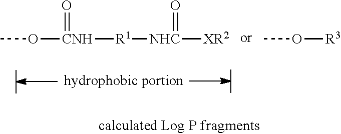

where the oxygen atom is covalently bonded to the polymer backbone (dashed line) through a saturated carbon atom; where R¹ is a divalent group and R² and R³ are monovalent groups selected to achieve the desired c Log P.

Preferably, R¹ is a C₄-C₁₄-alkyl, a C₅-C₈-cycloalkyl, or a combination of C₁-C₉-alkyl and C₅-C₇-cycloalkyl groups.

Preferably, R² is a C₃-C₁₂-alkyl, a C₅-C₈-cycloalkyl, or a benzyl group; X is O or NR^{2′} where R^{2′} is H or a monovalent group selected to achieve the desired c Log P. Preferably R^{2′} is H, a C₂-C₆-alkyl, or a C₅-C₈cycloalkyl group.

R³ is preferably a C₉-C₁₆-alkyl, a dibenzylamino-C₂-C₅-alkyl, a di-C₄-C₈-alkylamino-C₁-C₄-alkyl, a C₆-C₈-alkylphenyl group, a dibenzyl amine butyl glycidyl ether alcohol adduct, or a dibenzyl amine 2-ethylhexyl glycidyl ether alcohol adduct.

Examples suitable capping agents include C₅-C₁₄ linear or branched alcohols; benzyl alcohol; di-C₅-C₁₀-amines; C₄-C₁₀-amines; dicyclohexyl amine; cyclohexyl amine; benzylmethyl amine; as well as C₁₀-C₁₆-alkyl-(EO)₁₋₄₀H; and bis(C₄-C₁₀-alkyl)amino-(EO)₁₋₄₀H. Examples of combinations of R¹, R², and R^{2′} groups within the scope of the desired c Log P range are illustrated in Table 1, and examples of R³ groups within the scope of the desired c Log P ranges are illustrated in Table 2.

TABLE 1
cLog P values of R¹, R², and R²′ Hydrophobic Fragments

| R¹ | R² | R²′ | X | cLog P |
|---|---|---|---|---|
| —H₁₂MDI- | CH₃(CH₂)₃— | — | O | 4.68 |
| —H₁₂MDI- | CH₃(CH₂)₂— | — | O | 4.15 |
| -IPDI- | benzyl | — | O | 3.87 |
| -IPDI- | CH₃(CH₂)₅— | — | O | 4.75 |
| -IPDI- | CH₃(CH₂)₄— | — | O | 4.22 |
| -IPDI- | CH₃(CH₂)₃— | — | O | 3.69 |
| -HDI- | CH₃(CH₂)₇— | — | O | 4.34 |
| -HDI- | CH₃(CH₂)₆— | — | O | 3.81 |
| -HDI- | CH₃(CH₂)₉— | — | O | 5.40 |
| -HDI- | CH₃(CH₂)₁₁— | — | O | 6.46 |
| -HDI- | (CH₃)₂CH(CH₂)₃CH(CH₃)(CH₂)₂— | — | O | 6.46 |
| -HDI- | CH₃(CH₂)₄— | CH₃(CH₂)₄— | NR²′ | 3.76 |
| -HDI- | 2,6,8,-trimethylnonanol | — | C | 5.85 |
| -HDI- | CH₃(CH₂)₇— | H | NR²′ | 3.95 |
| -HDI- | cyclohexyl | cyclohexyl | NR²′ | 4.05 |
| —H₁₂MDI- | CH₃(CH₂)₅— | — | C | 5.74 |
| —H₁₂MDI- | benzyl | CH₃— | NR²′ | 4.37 |
| —H₁₂MDI- | cyclohexyl | H | NR²′ | 4.74 |
| -IPDI- | CH₃(CH₂)₉— | H | C | 6.86 |
| -IPDI- | CH₃(CH₂)₃— | CH₃(CH₂)₃— | NR²′ | 4.62 |
| -IPDI- | CH₃(CH₂)₅— | H | NR²′ | 4.36 |

TABLE 2
cLog P values of R³ Hydrophobic Fragments

| O—R³ groups | clogP |
|---|---|
| 1-Decyl-O— | 3.89 |
| 1-Undecyl-O— | 4.42 |
| 1-Dodecyl-O— | 4.95 |
| 1-tridecyl-O— | 5.48 |
| 1-tetradecyl-O— | 6.01 |
| 2-Butyl-1-Octyl-O— | 4.82 |
| Bis(2-ethylhexyl)N(ethyl)-O— | 6.75 |
| DBA-BGE-O— | 4.56 |
| DBA-EHGE-O— | 6.54 |

DBA-BGE-O— and DBA-EHGE-O— refer to the remnant of a dibenzyl amine butyl glycidyl ether alcohol adduct and dibenzyl amine 2-ethylhexyl glycidyl ether alcohol adduct, respectively:

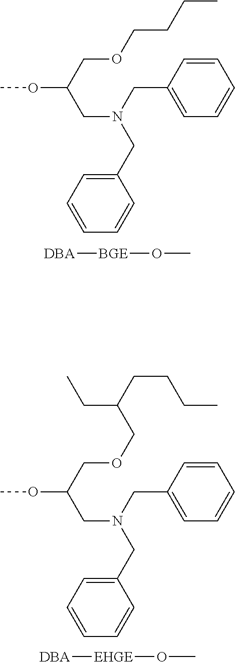

wherein the remnants arise from the corresponding alcohols.

In another aspect, the concentrations of the HEUR and the surfactant are in the range of from 10 to 20 weight percent, based on the weight of the composition, and at least 95 or at least 99 weight percent of the composition comprises water, the HEUR, and the surfactant. It has surprisingly been discovered that the composition of the present invention allows for significantly improved control of low-, mid-, and high-shear viscosities in paint formulations.

### EXAMPLES

HEURs were evaluated in the paint formulation shown in Table 3. TiO₂ refers to Ti-Pure R-746 Slurry; Dispersant refers to TAMOL™ 731 Dispersant; Defoamer 1 refers to BYK 348 Defoamer; Defoamer refers to Tego Poamex 810 Defoamer, Acrylic Latex refers to RHOPLEX™ VSR-2015 Acrylic Latex; and HEUR refers to the example and comparative example HEURs.

TABLE 3
Paint Formulation

| | Weight (g) |
|---|---|
| Premix | |
| TiO₂ | 349.8 |
| Dispersant | 7.5 |
| Defoamer 1 | 1.0 |
| Defoamer 2 | 0.5 |
| Total Premix | 358.80 |
| LetDown | |
| Water | 20.9 |
| Acrylic Latex | 524.2 |
| Defoamer 1 | 1.0 |
| Defoamer 2 | 0.5 |
| HEUR (15% w/w aq. soln.) | 46.7 |
| Water | 112.2 |
| Total LetDown | 705.5 |
| Total | 1064.0 |

### Preparation of HEURs

### Comparative Example 1-Non-Branched HEUR with No Surfactant

A mixture of CARBOWAX™ 8000 Polyethylene Glycol (PEG 8000, 100 g, A Trademark of The Dow Chemical Company or its Affiliates) and toluene (400 g) was heated to reflux and dried by azeoptropic distillation for 2 h. The reactor was then cooled to 90° C., whereupon Hexamethylene diisocyanate (HDI, 2.69 g) was added to the reactor with stirring for 5 min. Dibutyl tin dilaurate (0.21 g) was then added and the reaction mixture stirred for 1 h at 90° C. The reaction mixture was cooled to 80° C. and 1-decanol (1.84 g) was added to the reactor. The resulting mixture was stirred at 80° C. for 1 h. Solvent was removed in vacuo to yield the non-branched HEUR polymer. The non-branched HEUR polymer was dissolved in water in the presence of methyl-β-cyclodextrin (CD) to achieve a final polymer solution composed of 15 wt % non-branched HEUR polymer, 1 wt % CD, and 79 wt % water.

### Comparative Example 2-Non-Branched HEUR with Ethox CO-81 Surfactant

The procedure described in Comparative Example 1 was followed, except the non-branched HEUR polymer was dissolved in water in the presence of Ethox CO-81 surfactant (HLB=15.9) to achieve a final polymer solution composed of 15 wt % non-branched HEUR polymer, 13 wt % Ethox CO-81 surfactant, and 72 wt % water.

### Comparative Example 3-Non-Branched HEUR with Tergitol 15-S-9 Surfactant

The procedure described in Comparative Example 1 was followed, except the non-branched HEUR polymer was dissolved in water in the presence of Tergitol 15-S-9 surfactant (HLB=13.3) to achieve a final polymer solution composed of 15 wt % non-branched HEUR polymer, 13 wt % Tergitol 15-S-9 surfactant, and 72 wt % water.

### Comparative Example 4-HEUR Prepared from a Triol with No Surfactant

A mixture of PEG 8000 (100 g) and Lumulse POE (26) glycerine (2.43 g) in toluene (400 g) was heated to reflux and dried by azeoptropic distillation for 2 h. The reactor was then cooled to 90° C., whereupon HDI (3.31 g) was added to the reactor with stirring for 5 min. Dibutyl tin dilaurate (0.21 g) was then added and the reaction mixture stirred for 1 h at 90° C. The reaction mixture was cooled to 80° C., then 1-decanol (2.15 g) was added to the reactor. The resulting mixture stirred at 80° C. for 1 h, after which time solvent was removed in vacuo to yield the HEUR polymer. The HEUR polymer was dissolved in water in the presence of CD to achieve a final polymer solution composed of 15 wt % HEUR polymer, 1 wt % CD, and 79 wt % water.

### Comparative Example 5-HEUR Prepared from a Triol with Ethox CO-81 Surfactant

The procedure described in Comparative Example 4 was followed, except the HEUR polymer was dissolved in water in the presence of Ethox CO-81 surfactant to achieve a final polymer solution composed of 15 wt % HEUR polymer, 13 wt % Ethox CO-81 surfactant, and 72 wt % water.

### Comparative Example 6-HEUR Prepared from a Triol with Tergitol 15-S-9 Surfactant

The procedure described in Comparative Example 4 was followed, except the HEUR polymer was dissolved in water in the presence of Tergitol 15-S-9 surfactant to achieve a final polymer solution composed of 15 wt % HEUR polymer, 13 wt % Tergitol 15-S-9 surfactant, and 72 wt % water.

### Comparative Example 7-Branched HEUR Prepared from a Triisocyanate with No Surfactant

PEG 8000 (1700 g) was heated to 110° C. in vacuo in a batch melt reactor for 2 h. The melt was cooled to 85° C. under N₂, whereupon a mixture of butylated hydroxytoluene (0.173 g) and 1-decanol (25.67 g) were added to the reactor. The mixture was stirred for 5 min, after which time hexamethylene diisocyanate (HDI, 41.09 g) and Desmodur N3600 HDI Trimer (8.70 g) were added to the reactor. The reaction mixture was stirred for 5 min, then bismuth octoate (28% Bi, 4.25 g) was then added to the reactor. The mixture was stirred for 8 min at 85° C., after which time the resulting molten polymer was removed from the reactor and cooled to yield the branched HEUR polymer. The branched HEUR polymer was dissolved in water in the presence of CD to achieve a final polymer solution composed of 15 wt % branched HEUR polymer, 1 wt % CD, and 79 wt % water.

### Example 1-Branched HEUR Prepared from a Triisocyanate with Ethox CO-81 Surfactant

The procedure described in Comparative Example 7 was followed, except the branched HEUR polymer was dissolved in water in the presence of Ethox CO-81 surfactant to achieve a final polymer solution composed of 15 wt % branched HEUR polymer,
13 wt % Ethox CO-81 surfactant, and 72 wt % water.

### Example 2-Branched HEUR Prepared from a Triisocyanate with Tergitol 15-S-9 Surfactant

The procedure described in Comparative Example 7 was followed, except the branched HEUR polymer was dissolved in water in the presence of Tergitol 15-S-9 surfactant to achieve a final polymer solution composed of 15 wt % branched HEUR polymer, 13 wt % Tergitol 15-S-9 surfactant, and 72 wt % water.

Table 4 illustrates the ICI, KU, and Brookfield viscosity data for paints prepared from the examples and comparative examples. ICI viscosities are reported in units of Poise (P); KU viscosities are reported in units of Krebs units; and the Brookfield viscosities are reported in units of centipoise (cP).

TABLE 4
Viscosity Data for Paints

| Ex. No. | Surfactant | ICI (P) | KU | B_{f} (cP) | ICI/KU * 100 |
|---|---|---|---|---|---|
| Comp. Ex. 1 | none | 1.50 | 83.2 | 3419 | 1.80 |
| Comp. Ex. 2 | CO-81 | 1.15 | 69.2 | 1040 | 1.66 |
| Comp. Ex. 3 | 15-S-9 | 0.85 | 63.6 | 740 | 1.34 |
| Comp. Ex. 4 | none | 1.30 | 80.4 | 3199 | 1.62 |
| Comp. Ex. 5 | CO-81 | 1.10 | 68.1 | 1000 | 1.62 |
| Comp. Ex. 6 | 15-S-9 | 0.90 | 63.1 | 700 | 1.43 |
| Comp. Ex. 7 | none | 1.90 | 95.8 | 5219 | 1.98 |
| Ex. 1 | CO-81 | 1.50 | 75.4 | 1840 | 1.99 |
| Ex. 2 | 15-S-9 | 1.40 | 71.6 | 1140 | 1.96 |

For formulators to have flexibility in formulating paints in the optimal low-, mid-, and high-shear ranges, the highest ICI/KU ratios, coupled with the lowest KU and Brookfield viscosities, are the most desirable. Only the formulations containing the branched HEUR and the surfactant in the designated HLB range yielded acceptable ICI/KU ratios and KU values, along with lower Brookfield viscosities.

1. A composition comprising an aqueous solution of a branched HEUR and a nonionic surfactant having an HLB in the range of 11 to 19; wherein the branched HEUR is capped with a hydrophobic portion having a c Log P in the range of 3.5 to 7.0; the concentration of the HEUR is in the range of from 10 to 25 weight percent, based on the weight of the composition; the concentration of the surfactant is in the range of from 5 to 25 weight percent, based on the weight of the composition; and at least 90 weight percent of the composition comprises water, the HEUR, and the surfactant.

2. The composition of claim 1 wherein the nonionic surfactant is a saturated or partially unsaturated C₆-C₆₀-alkyl alkoxylate with from 2 to 100 alkylene oxide groups.

3. The composition of claim 1 wherein the nonionic surfactant is a saturated or partially unsaturated C₆-C₃₀-alkyl ethoxylate with from 2 to 50 ethylene oxide groups; wherein the nonionic surfactant has an HLB in the range of 13 to 18.

4. The composition of claim 3 wherein the nonionic surfactant is lauryl-O-(EO)₅₋₁₇H, tridecyl-O-(EO)₅₋₁₈H, castor oil-(EO)₂₀₋₈₁H, octadecyl-O-(EO)₆₋₃₁H, stearyl-O-(EO)₆₋₃₁H, octylphenyl-O-(EO)₅₋₂₀H, nonylphenyl-O-(EO)₅₋₂₀H, or tallow amine (EO)₆-C₂₅H.

5. The composition of claim 1 wherein the branched HEUR has a hydrophobic portion characterized by the following formula: 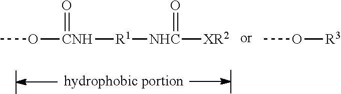
where the oxygen atom is covalently bonded to the polymer backbone (dashed line) through a saturated carbon atom; where R¹ is a divalent group and R² and R³ are monovalent groups selected to achieve the desired c Log P.

6. The composition of claim 5 wherein R¹ is a C₄-C₁₄-alkyl, a C₅-C₈-cycloalkyl, or a combination of C₁-C₉-alkyl and C₅-C₇-cycloalkyl groups; R² is a C₃-C₁₂-alkyl, a C₅-C₈-cycloalkyl, or a benzyl group; X is O or NR^{2′} where R^{2′} is H or a monovalent group selected to achieve the desired c Log P; and R³ is a C₉-C₁₆-alkyl, a dibenzylamino-C₂-C₅-alkyl, a di-C₄-C₈-alkylamino-C₁-C₄-alkyl, a C₆-C₈-alkylphenyl group, a dibenzyl amine butyl glycidyl ether alcohol adduct, or a dibenzyl amine 2-ethylhexyl glycidyl ether alcohol adduct.

7. The composition of claim 4 wherein the branched HEUR has a hydrophobic portion characterized by the following formula: 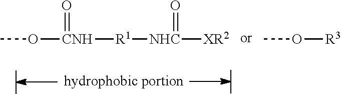
where the oxygen atom is covalently bonded to the polymer backbone (dashed line) through a saturated carbon atom; R¹ is C₄-C₁₄-alkyl, a C₅-C₈-cycloalkyl; R² is a C₃-C₁₂-alkyl, a C₅-C₈-cycloalkyl, or a benzyl group; R^{2′} is H, a C₂-C₆-alkyl, or a C₅-C₈cycloalkyl group; and R³ is a C₉-C₁₆-alkyl, a dibenzylamino-C₂-C₅-alkyl, a di-C₄-C₈-alkylamino-C₁-C₄-alkyl, a C₆-C₈-alkylphenyl group, a dibenzyl amine butyl glycidyl ether alcohol adduct, or a dibenzyl amine 2-ethylhexyl glycidyl ether alcohol adduct.

8. The composition of claim 1 wherein the concentration of the nonionic surfactant and the concentration of the HEUR are in the range of from 10 to 20 weight percent, based on the weight of the composition; and at least 95 percent of the composition comprises water, the HEUR, and the nonionic surfactant.
